(19) United States
(12) Patent Application Publication
(10) Pub. No.: US 2026/0228211 A1
(43) Pub. Date: Aug. 6, 2026

(54) Support For Externally Trained Machine Learning Model In A Relational Database

(71) Applicant: Oracle International Corporation, Redwood Shores, CA (US)

(72) Inventors: Laurent Phillipe Daynes, Saint-Ismier (FR); Lukas Gelbmann, Zurich (CH)

(21) Appl. No.: 19/043,597

(22) Filed: Feb. 3, 2025

(51) Int. Cl. G06F 16/242; G06F 16/21; G06F 16/22; G06F 16/25; G06N 20/00

(52) U.S. Cl. CPC G06F 16/2448; G06F 16/213; G06F 16/2282; G06F 16/258; G06N 20/00

(57) ABSTRACT

A database system includes functionality to import externally trained models, which may be converted into a standard interchange format as first-class objects in a relational database. The database system also provides support for integrating inference generation using externally trained machine learning models with database queries or relational statements. The database system includes a machine learning runtime engine for invoking the imported ML models to generate inferences without exporting database data between the database system and an external inference engine.

### FIELD OF THE INVENTION

The present invention relates to importing and maintaining externally trained machine learning models as first-class objects in a relational database management system (RDBMS) and operators for model inference within the RDBMS.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

Vectors have become essential to densely represent any kind of data and enabling efficient similarity searches on them using vector indexes. Specialized and general-purpose databases provide search capabilities based on vector similarity, wherein data are associated with particular vector values and similarity is determined according to some distance function between vectors that represent a position in multi-dimensional vector space.

The generation of vector values typically requires execution of a sophisticated machine learning model trained to capture particular characteristics of some data (e.g., text, image, audio, video, time series, etc.) into a vector representation. Without support for execution of these models within the database, generation of the vectors requires sending the data outside of the database, producing vector values on dedicated embedding model inference engines, and bringing back the vector values into the database for storing and indexing. This adds complexity to database application development, because at least two systems are involved in building an index: the embedding generation system and the vector storage and indexing system. Such an architecture presents privacy and security issues, reliability issues, and possibly performance issues. Data must be moved out of the database system to an external service to generate embeddings. Furthermore, failures during index building (e.g., a model inference engine failing while generating an embedding) must be taken care of outside of the database itself, increasing the complexity of application development. In addition, building a large index requires moving a large amount of data between the database and the inference engine, which are loosely coupled.

Moreover, for a database system with a high-level query language interface, there is no easy way to express queries or Data Manipulation Language (DML) statements involving vector embedding generation. A deep integration of vector embedding generation would allow users to simply integrate embedding generation with any SQL queries and be able to express both input to similarity search and to DMLs for updating a vector index.

### BRIEF DESCRIPTION OF THE DRAWINGS

In the drawings:

FIG. 1 is a block diagram of a database system that supports import of externally trained machine learning models in accordance with an embodiment.

FIG. 2 is a block diagram of a database system that supports integrating inference generation using externally trained machine learning models with database queries or relational statements in accordance with an embodiment.

FIG. 3 is a flowchart illustrating operation of interfacing a database execution engine to a machine learning runtime in accordance with an embodiment.

FIG. 4 is a block diagram illustrating loading of a machine learning model and creation and caching of machine learning runtime sessions for operations invoking machine learning models in a database server in accordance with an embodiment.

FIG. 5 is a flowchart illustrating operation of providing a machine learning runtime session to a database operator in accordance with an embodiment.

FIG. 6 is a block diagram that illustrates a computer system upon which an embodiment of the invention may be implemented.

FIG. 7 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments provide functionality to import externally trained models, which may be converted into a standard interchange format, such as the Open Neural Network eXchange (ONNX) format, as first-class objects in a relational database. The illustrative embodiments also provide support for integrating inference generation using externally trained machine learning models with database queries or relational statements. In some embodiments, the database system includes functionality to use imported ML models in scoring operators, integrated with the Structured Query Language (SQL) and executed efficiently within a SQL execution engine. Some embodiments focus on importing pre-trained (fine-tuned or not) embedding models, such as popular sentence transformers or contrastive language-image deep learning models and new operators for generating vector embedding in queries and DMLs using them. The embodiments are primarily described with respect to support for externally trained embedding models; however, the illustrative embodiments can be generalized to any machine learning model trained externally for tasks as diverse as Named Entity Recognition (NER), re-reranking, summarization, object detection, etc.

Some embodiments extend the expressive power of declarative query language to support new scoring operations for machine learning models that are trained outside of a database system, such as models for generating vector embeddings of both text and unstructured data such as images, audio, video, etc. These embodiments comprise three parts:
Importing and maintenance of externally trained models as first-class objects in a relational database, using an open interchange format for machine learning models, such as the Open Neural Network eXchange (ONNX) format.
A new operator (e.g., a VECTOR_EMBEDDING operator) that generates embedding values according to an embedding model, wherein the embedding operator takes as input any column expression producing a value of the type expected by the embedding models (e.g., data type that can convert to textual form, or binary large object (BLOB) for any kind of non-textual unstructured data, such as images). The operator can be used in predicates, projection, and complex expressions over vector data type. The operator can be used in DML statements to generate vector values that can be stored in columns accepting vector data type. The mechanisms described for the operator can be applied to other scoring operators, requiring only trivial changes in parsing, semantic analysis of the input, and input/output type verification.
A tight coupling of a query execution engine to execute externally trained models in queries and DML operations.

The illustrative embodiments minimize the cost of inference session creation for ML models across multiple invocations of SQL scoring operators, within and across queries. The illustrative embodiments provide a generalized method to describe, at model import time, how SQL scoring operators interact with the models using a simple declarative metadata description and how query compile-time checks verify and direct input from a SQL scoring operator to an imported ML model and direct ML model output to SQL scoring operators.

The illustrative embodiments enable database users to very simply write applications that generate vectors, in a manner that integrates with the SQL syntax. The illustrative embodiments allow database users to benefit from the latest innovations in machine learning models by enabling importing of externally developed and trained models. The embodiments avoid exposing potentially sensitive data to an external service to execute ML model inferences (e.g., embedding generation). The embodiments avoid expensive movement of data between a database and a third-party ML model inference (e.g., embedding) service. The embodiments also reduce the complexity of database applications in need of embedding generation to index data, because reliability and recovery protocols are automatically handled by the database as opposed to having the application or the middle tier layers taking care of recovering from failures from any of the multiple parties involved. The embodiments also allow database users, with no direct access to outside AI service providers, to execute ML inferences based on their database-resident data.

### Model Development and Training

Machine learning (ML) has become an indispensable complement to traditional data analysis. A large palette of tools, frameworks, and services are now available to develop and train ML models, or to customize existing models pre-trained using such tools, frameworks, and services. Ecosystems providing such ready-to-use pre-trained models are emerging quickly, democratizing the use of ML in many applications. A new generation of data scientists develops ML models primarily on these platforms. Therefore, it is beneficial to make such externally trained models available for use in both complex analytical queries and online transaction processing executed by relational database systems.

Deep learning software frameworks exist for developing and training machine learning (ML) models. For example, the Apache MXNet™ framework is an open-source deep learning software framework that trains and deploys deep neural networks. The PyTorch™ framework is a machine learning library based on the Torch library, which is used for applications such as computer vision and natural language processing. The TensorFlow™ framework is a software library for machine learning and artificial intelligence. The sickit-learn™ framework is a free and open-source machine learning library for the Python™ programming language that features various classification, regression, and clustering algorithms, including support-vector machines, random forests, gradient boosting, k-means and DBSCAN. These and other ML development and training frameworks, tools, and services are used by developers to develop, train, and customize ML models for various tasks and use cases.

### Framework Interoperability and Model Representation

The Open Neural Network eXchange (ONNX) format is an example of a format built to represent machine learning models for interoperability between models developed using different frameworks. ONNX defines a common set of operators (the building blocks of machine learning and deep learning models) and a common file format to enable artificial intelligence (AI) developers to use models with a variety of frameworks, tools, runtimes, and compilers. ONNX supports many existing model development and training frameworks and allows a developer to create models in the developer's preferred framework without downstream inferencing implications. ONNX also provides runtime engines (runtimes) that execute on a variety of hardware platforms, making it easier to access hardware optimizations. ONNX-compatible runtimes and libraries are designed to maximize performance across hardware.

ONNX is an open-source, open-model format that defines a small number of abstractions to represent an ML model. A model is represented as a graph of mostly mathematical operators. The entry points to the graph are input values (often tensors), the exit points are output values (also often tensors). A tensor is an object that describes a multilinear relationship between sets of objects related to a vector space. Each operator in the graph may have attributes that further refine the behavior of the operator. For example, the general matrix multiplication operator can be parameterized with attributes to specify that, for example, its left or right operands or both must be transposed prior to performing the matrix multiplication, or an attribute that specifies that a scalar multiplier must be applied to the result of the matrix multiplication, etc.

Inference of ONNX models is primarily supported by an ONNX runtime, which offers a session-based execution model. A session must first be created to execute a specific model. The session can then be used to run as many inferences of that model as needed. Creating a session takes in a model and some options that can be used to specify resource usage (e.g., how many threads can be used), or what specific custom operation may extend the basic set of operation supported by the runtime.

### Model Import Into RDBMS

In accordance with the illustrative embodiments, a machine learning runtime engine, such as an ONNX runtime, is implemented within the RDBMS. The machine learning runtime engine allows import and execution of existing, pre-trained ML models, such as an embedding model for generating vector representations of data within the database. The illustrative embodiments assume a machine learning inference engine, such as a machine learning runtime engine based on the ONNX format.

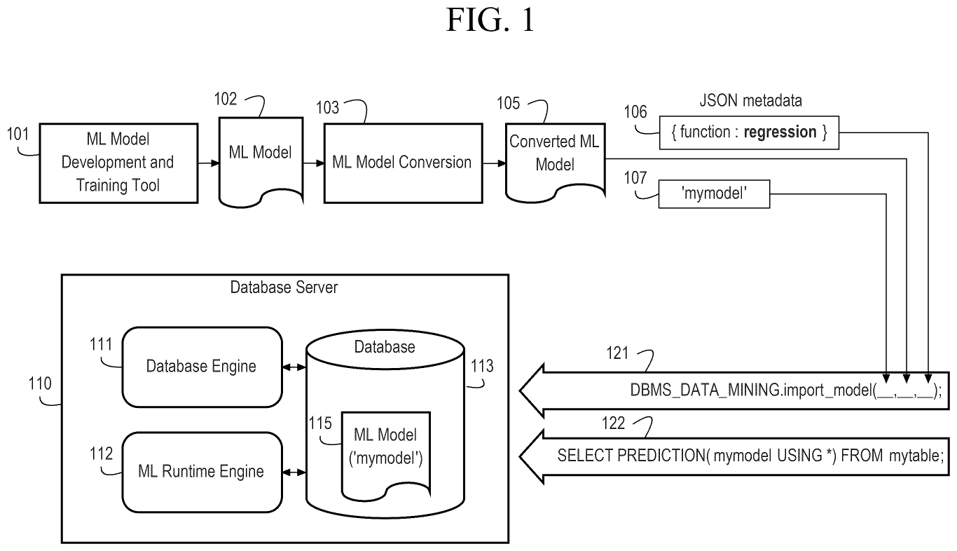

FIG. 1 is a block diagram of a database system that supports import of externally trained machine learning models in accordance with an embodiment. Users may have trained their own models or may want to use third-party open-source models obtained from popular AI providers. For example, ML model 102 may be developed using ML model development and training tool 101. In some embodiments, ML model development and training tool 101 may be the Apache MXNet™ framework, the PyTorch™ framework, the TensorFlow™ framework, or the sickit-learn™ framework, for example.

To start using ML model 102, the model 102 is converted to an interchange format representation using ML model conversion tool 103, thus generating converted ML model 105, in order to ease its deployment to database server 110. In the embodiment shown in FIG. 1, database server 110 includes database 113 and employs database engine 111 and machine learning runtime engine 112. In an embodiment, ML model conversion tool 103 employs a converting software library for converting models from ML model development and training tool 101 to the ONNX format, and ML runtime engine 112 is a model inference server powered by an ONNX runtime.

The embodiments allow users to deploy converted ML model 105 to a relational database and use the model in SQL queries and DML using an operator that supports ML model inference. To this end, the converted model 105 is imported into the database to create a named database object that can be used in an operation with the appropriate privilege. Import operation 121 includes attributes that specify a name for the model 107, the binary object of the converted ML model 105, and metadata 106 for the model. In one embodiment, the binary object for the converted ML model 105 is a binary large object (BLOB), and the model metadata is in JavaScript Object Notation (JSON) format.

In the example depicted in FIG. 1, import operation 121 is as follows:

DBMS_DATA_MINING.import_model(’mymodel’, [BLOB],
JSON(’{″function″: ″regression″}’));

This specifies importing the model for database data mining. The model metadata 106 specifies that the model is a regression model. The particular syntax in the depicted example is not intended to be limiting. The syntax for importing a model must allow:
Specifying a value holding an interchange format representation (e.g., the ONNX representation) of the model. For most database systems, this representation may be a BLOB value.
Specifying a name, and optionally a schema, to create a database object representing the model (if not specified, the schema of the user importing the model is used).
   Importing a model results in creating a named database object in database 113. The use and maintenance of ML model object 115 is controlled by specific privileges. Metadata 106, needed for query compilation and execution, are tracked and by database server 110, typically in the database catalog.

Once created, model object 115 can be used with an operator to obtain the result of an inference of the imported model. The syntax for operators must allow specifying:
An identifier of the object that represents the model that was previously imported, such that appropriate privilege control and auditing can be performed at query compilation time on the identified object.
Input attributes with type compatible with the input expected by the specified model (e.g., a textual data type if the model is a sentence transformer, or a BLOB if the model takes unstructured data, such as images, as input, multiple numeric values if the model is a regression model, etc.). Each input value may be a literal value, a bind variable, a table/view column, or the result of a column expression.

In the depicted example, a statement 122 including an operator is as follows: “SELECT PREDICTION(mymodel USING *) FROM mytable;”. In this example, the operator (PREDICTION) identifies the model name (mymodel) and specifies input attributes (USING *).

### Creating a Database Object From a Machine Learning Model

In accordance with some embodiments, the ML model 115 imported into the database is represented as a first-class object, also referred to as a first-class citizen, in the database server 110. In the context of a database, a first-class citizen refers to an entity that is fully supported and treated as a primary component within the database system. This means that it can be directly manipulated, queried, and managed using the native operations and features of the database system. For example, in a relational database, tables and rows are first-class citizens, because one can perform operations, such as SELECT, INSERT, UPDATE, and DELETE, directly on them. Similarly, in some modern databases, more complex data types like JSON documents or graph nodes and edges are treated as first-class citizens, allowing for direct manipulation and querying. Similar to tables or views, ML model 115 is referenced by a unique name within the schema where it is imported and associated with a system-wide unique database object number. It can also be subject to privilege control, auditing, etc. Once imported, ML model 115 resides in the database until explicitly dropped.

When importing an ML model into database server 110, the following information must be defined in a dictionary table associated with the database object created for the model:
Information necessary to the SQL compiler to correctly perform semantic analysis on queries and DML statements that use the model via an operator that is enabled for the model
Information necessary for database engine 111 to obtain a runtime session with ML runtime engine 112 from the identified model and to describe how to interface the operator with the runtime session (e.g., how input column values are communicated via tensors to the session created for the model).

Not all information for interfacing an operator with a runtime session for inference can be inferred from an ML model alone. In particular, there is no convention for how the input and output of a converted model are organized. Tools for different frameworks may adopt different conventions. The following information is obtained from the user at model import time: what operators can be supported by the ML model; how values passed to an operator map to the input of the ML model; which values returned by the ML model, if multiple, must be passed to the operator; and, what to do in case of a NULL input.

In some embodiments, the ML model metadata 106 is provided as a JavaScript Object Notation (JSON) document including the following:

### Function (String)

A name that identifies what function is supported by the ML model. For example, “embedding” indicates that the model supports a vector embedding (VECTOR_EMBEDDING) scoring operator, “classification” indicates that the model supports a prediction (PREDICTION) or prediction probability (PREDICTION_PROBABILITY) operator, “clustering” indicates that the model supports a cluster distance (CLUSTER_DISTANCE) or cluster identifier (CLUSTER_ID) operator, etc.

### Input (Object)

An object that comprises as many fields as there are input tensors to the model, wherein the name of each field is the name of an input tensor, and each field value is an array of string values that correspond to the attribute name. For example, for a model with two input tensors of the type float32[?,2] named respectively “x” and “y,” the “input” field can be declared as follows:

{... “input” : { “x” : [“x1”, “x2”], “y” : [“y1”, “y2”]} ...}

This tells the database that the operators for this model must provide values of a type that can be converted to ONNX's float32 data type and each value must be associated with a model attribute name that matches one of the values specified in one of the arrays declared in the “input” field of the JSON descriptor.

The syntax adopted for illustration uses an AS clause when there is no attribute name, or the attribute name associated with an input of an operator does not match one declared in the “input” field. For example, consider statement 122 is as follows:

SELECT PREDICTION(mymodel USING 3.56 AS x1, −5.55 as x2, 753.2
AS y1, 34.5 AS y2);

This statement shows how literal values can be mapped to input attribute names. The names specified in the attribute must follow the convention of SQL identifiers. In particular, an unquoted name specified as an attribute name, like “X1,” corresponds to the identifier x1, while an attribute name, like “\“x1\” corresponds to the identifier “x1.”
<xxx>Output (String)

A name that identifies the output tensor from the model that provides the result of an operator. For example, an embedding model will have one tensor holding the vector embedding generated for the model input. A field with a name specific to the VECTOR_EMBEDDING operator, e.g., “embeddingOutput,” must be declared by the user to specify which output tensor of the model holds the vector embedding generated for the model input. Similarly, “regressionOutput” can be used to specify the output tensor that holds the result of the PREDICTION operator for a regression model.

### Default on Input (Object)

The ONNX format has no representation for non-existent values, i.e., there are no equivalents to the NULL value in SQL. Furthermore, ONNX models do not tolerate that some of their input values are not specified. The illustrative embodiments solve this problem by skipping the interface when at least one input value to an ONNX model is used and NULL is returned as a result. The embodiments comprise an alternative solution where users may specify a default value for each input attribute, in which case, an operator replaces the NULL value passed to an input attribute with the default value specified for the input attribute name in the “defaultOnNull” field.

The value of the “defaultOnNull” field is an object the field name of which is an input attribute name, as specified in the “input” field and the value of which is a literal value. For example, if the data to be scored can have NULL for its y1 and y2 input attributes, the following can be used to specify replacement and to enable inference on rows with NULL values for y1 or y2:

```
{ ...
  “input” : { “x” : [“x1”, “x2”], “y” : [“y1”, “y2”]},
  “defaultOnNull” : {“y1” : 0.0, “y2” : 0.0}
}
```

Importing a model requires three inputs:
1. A schema qualified object name, to be given to the database object that will represent the imported model.
2. A BLOB that holds the bytes representing the model in the ONNX format.
3. A JSON descriptor that provides the necessary information.

For example, a system-defined procedural language/structured query language (PL/SQL) package, like the DBMS_DATA_MINING package in an Oracle® database system, may provide an interface to import a model as follows:

```
PROCEDURE import_onnx_model (model_name IN VARCHAR2,
  model_data IN BLOB,
  metadata IN JSON;
```

Implementations of the embodiments may use a default value to simplify use of the procedure for the most common case and automatically provide default JSON description. For example, a system that assumes that the most frequent use would be for embedding, the model can provide a simpler API that makes the JSON metadata optional. For example, the PL/SQL package may provide an an interface to import a model as follows:

```
  PROCEDURE load_onnx_model (
  model_name IN VARCHAR2,
  model_data IN BLOB,
  metadata IN JSON default json(‘{“function” : “embedding”,
“embeddingOutput” : “embedding”, “input” : {“input”:
[“DATA”]}}’)
);
```

Importing a model goes through several validations of the model before generating the database dictionary information necessary to create a database object.

The dictionary information for defining an ONNX model may comprise the following information:
1. A table holding a BLOB containing the bytes representing the model in the ONNX format and a character large object (CLOB) containing the JSON description provided by the user;
2. A table describing the mapping of model input to input attribute name. The table holds (at least) the following information.
   a. ATTRIBUTE_NAME: the name of the input attribute, as expected by an operator;
   b. INPUT_NAME: the name of the model input tensor holding the value for the ATTRIBUTE_NAME;
   c. POSITION: the index in the input tensor that maps to the input attribute;
3. A table summarizing the information inferred from the ONNX model itself and provided by the user, such as:
   a. The function of the model (e.g., embedding, classification, regression, etc.);
   b. The name, type, size, and shape of the input and output tensors of the model;
   c. What output corresponding to the result of the operation (some models may support more than one operation and may provide multiple outputs);
   d. The default value to use for each input attribute when an input is NULL.
   e. Whether the model supports batching or not;
   f. User provided labels (if any) for models for which result may be replaced with labels (e.g., classification models).

### Model Inference in RDBMS

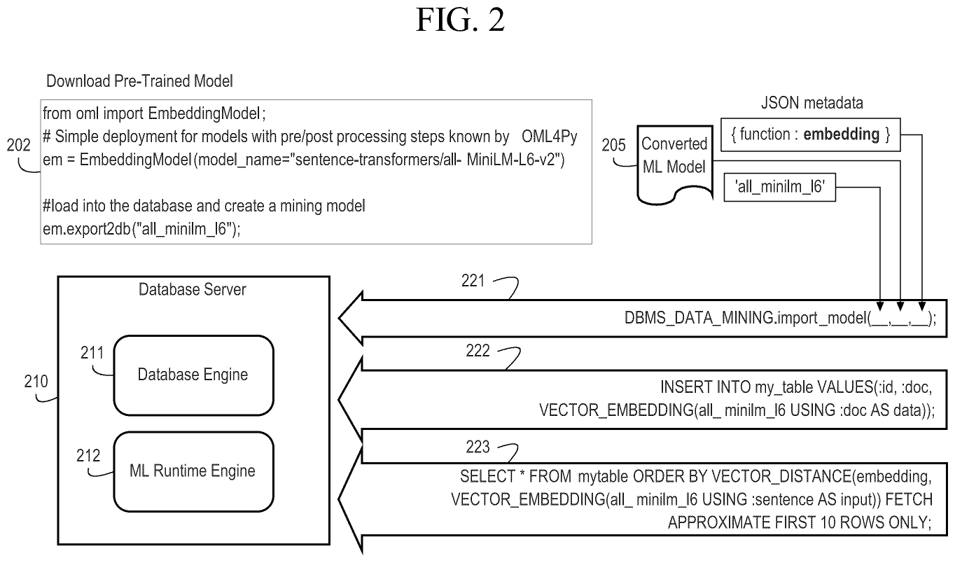

FIG. 2 is a block diagram of a database system that supports integrating inference generation using externally trained machine learning models with database queries or relational statements in accordance with an embodiment. A user downloads a pre-trained model 202 and imports converted ML model 205 using an import operation 221. In the depicted example, import operation 221 is as follows:

DBMS_DATA_MINING.import_model(‘all_minilm_l6’, [BLOB],
JSON(‘{“function”: “embedding”}’));

This specifies importing the model for database data mining. The model metadata specifies that the model is an embedding model.

In the depicted example, operation 222 is a DML operation as follows:

INSERT INTO my_table VALUES(:id, :doc,
VECTOR_EMBEDDING(all_minilm_l6 USING :doc AS data));

This operation inserts values into a table (my_table) using a vector embedding operator (VECTOR_EMBEDDING) that is designed to use an ML model (all_minilm_l6 in this case) to generate embeddings from a document.

Also, operation 223 is a query operation as follows:

SELECT * FROM mytable ORDER BY VECTOR_DISTANCE(embedding,
VECTOR_EMBEDDING(all_minilm_l6 USING :sentence AS input))
FETCH APPROXIMATE FIRST 10 ROWS ONLY;

This operation executes a query and orders the results by vector distance (VECTOR_DISTANCE) based on embedding vectors that are generated by an ML model (all_minilm_l6) using the vector embedding operator (VECTOR_EMBEDDING).

Executing the ML model inference from an operator invoked, from a DML operation or query, requires using in-database ML runtime 212 to create an inference session for the model specified by the operator. When database engine 211 executes an operation, such as DML operation 222 or SQL query 223, with an operator that is supported by an ML model that has been imported into database server 210, the operator (e.g., the VECTOR_EMBEDDING operator) obtains a session with ML runtime 212 for the model (e.g., all_minilm_l6) specified by the operator. How the session is obtained is described in further detail below.

To run a model inference, the input of the model must be provided in the representation expected by the ML runtime engine 112. When using data from database engine 111, data must be converted to the representation expected by the model (e.g., BLOB to vector of uint8 for an image). Inversely, the result of the model inference must be converted back to the representation expected by database engine 111 tensor to the corresponding database vector type).

As an example, an embedding model generating a vector embedding from text would typically have as input a string tensor (e.g., a string[?] tensor), and would output a tensor holding a vector tensor (e.g., a float32[?,768] tensor for a embedding model generating vector embedding with 768 dimensions). Similarly, an embedding model generating a vector embedding for an image would take a vector of bytes holding the bytes representing the image (e.g., a uint8[?] tensor) and output a vector value.

To run a model inference, the input of the model must be provided in the representation expected by the runtime. When using data from a database query engine, data must be converted to the representation expected by the model (e.g., BLOB to vector of uint8 for an image). Inversely, the result of the model inference must be converted back to the representation expected by the database query engine (e.g., a float32[?,768] tensor to the corresponding database vector type).

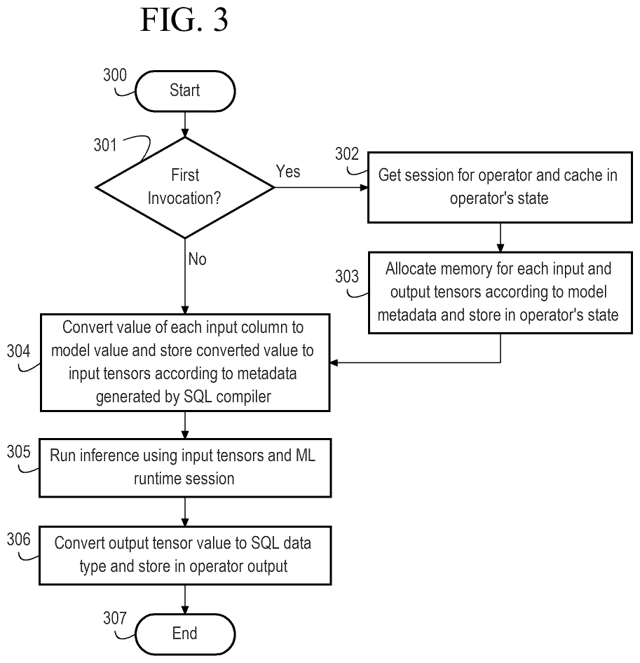

FIG. 3 is a flowchart illustrating operation of interfacing a database execution engine to a machine learning runtime in accordance with an embodiment. Operation starts (block 300), and the database server determines whether the current invocation of the ML model is the first invocation (block 301). If it is the first invocation (block 301: Yes), the operator obtains a session for the model specified by the operator, and a handle for the session is cached in the operator state (block 302). The database server allocates memory for each input and output tensors required for a single inference execution using the information generated by the query compiler based on the model metadata and the column expression passed as argument to the operator (block 303). This memory is allocated once and used repeatedly across multiple invocations of the ML model by the operator in the DML operation or query. The ML runtime requires additional information for the input and output tensors, e.g., their name for example. These are constant across multiple inferences and are known at compile-time so storage for their value is allocated at query-compile time and shared across all queries running an inference of the model.

Subsequent steps (blocks 304-306) are executed by all invocations of the operator. Thus, proceeding form block 303 or if the current invocation is not the first invocation (block 301: No), the database server uses information produced by the query compiler describing what column operand of the operator maps to what element of an input tensor to decide on what conversion of data type representation to use and where to store the result. The database system converts the value of each input column to a model value and stores the converted values to input tensors according to metadata generated by the SQL compiler (block 304).

In the case of the VECTOR_EMBEDDING operator, there can be only one operand. Depending on the model, the type must be either a textual data type (e.g., VARCHAR2, CLOB) or an unstructured type which must be passed to the operator as a BLOB. When the input data type is a VARCHAR2, the representation of the character string must be converted to character set expected for a string type (i.e., UTF8) supported by the ML runtime engine, and the memory reference to the resulting string stored in the tensor only element. When the input data type is a BLOB, the reference of its storage in memory is stored in the tensor only element as a vector of uint8 type (i.e., a vector of bytes).

The database server then invokes the ML runtime to run the model inference using the input tensors in the ML runtime session (block 305). The database server converts the result of the inference stored in the output tensor, typically a vector type, into the database representation of a vector and stores the result vector in the location of the result for the operator (block 306). Thereafter, operation ends (block 307). On termination of the DML or query operation completes, the memory allocated to the tensors needed for the inference is released, and the ML runtime session is released. The release of these resources may take place before the end of the query. Typically, on large queries consisting of many sub-queries, the release of resources, if used only by a sub-query, may take place as soon as the sub-query no longer returns any rows.

### Caching ML Runtime Sessions

Providing each invocation of an operator scoring an ML model with an ML runtime session for that model is performance critical. Creating an inference session involves passing the model bytes to the ML runtime, which will deserialize the representation into a more optimal representation of the ML model graph in memory, and may perform some optimization over the graph, depending on the specified optimization (e.g., basic (e.g., constant-folding, redundant operator elimination, etc.) to extended (e.g., operator fusions, etc.). Further, embedding models can be large. For example, popular pre-trained models such as ALL-MPNET-BASE-V2 or CodeBERT-base have size between 416 and 475 MBs once converted to ONNX without compression optimization such as quantization, and models can be much larger, e.g., beyond 1 GB for Multilingual-E5-base.

It is therefore essential to avoid creating a session on every invocation of an operation, such as VECTOR_EMBEDDING, within the same query, and ideally even across multiple queries within a database session. To this end, a cache of ML runtime session(s) is maintained per database session. The cache maps a unique database object identifier assigned to the imported ML model. Caching an ML runtime session across multiple invocations and across queries also saves from loading model bytes from dictionary tables, which is even more expensive than creating an ONNX runtime session. There may be multiple scoring operators for the same model in a query, and the cache of an ML runtime session can cache the model across multiple database statements.

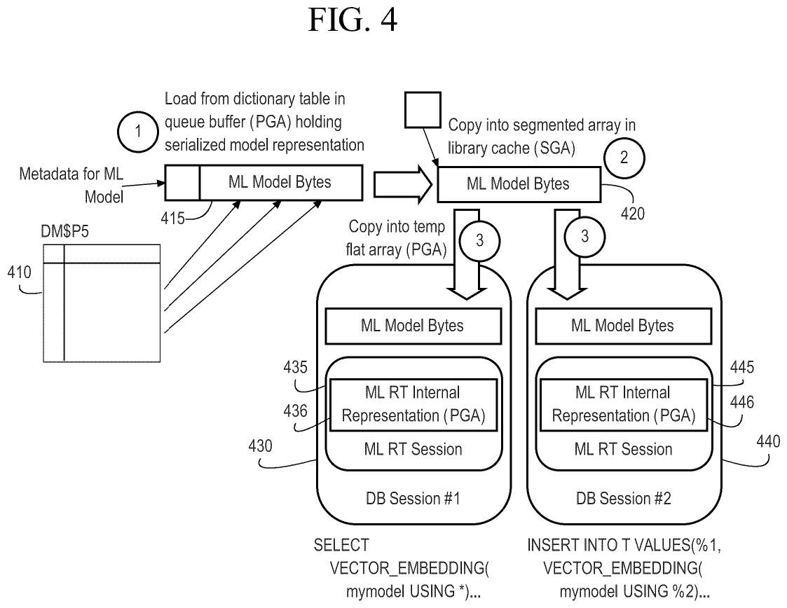

FIG. 4 is a block diagram illustrating loading of a machine learning model and creation and caching of machine learning runtime sessions for operations invoking machine learning models in a database server in accordance with an embodiment. In step 1, the database system loads the ML model from dictionary table 410 into the queue buffer (Program Global Area (PGA)) holding a serialized model representation. Loading the ML model involves loading the metadata for the ML model and the ML model bytes 415. In one embodiment, the model is loaded in chunks that are less than or equal to 2 KB.

In step 2, the database server then copies the ML model bytes 420 into the segmented array in the library cache (System Global Area (SGA)). On first invocation of an operation (e.g., a DML or query) involving an operator that is supported by an ML model that is imported into the database server, the database server copies the ML model bytes into a flat array in the PGA (step 3). In the example shown in FIG. 4, the operation is as follows: SELECT VECTOR_EMBEDDING(mymodel USING *) . . . Thus, the database server creates database session #1 430 for this operation. Within DB session #1 430, the VECTOR_EMBEDDING operator invokes the ML model, and the database engine creates ML runtime session 435 with ML runtime internal representation (PGA) 436. A ML runtime session is a materialized representation of the model that is prepared for execution. The database engine can then begin passing operands as input tensors to the model, which returns output as one or more output tensors.

Subsequently, the database system processes the following operation: INSERT INTO T VALUES(%1, VECTOR_EMBEDDING(mymodel USING %2) . . . For this operation, in step 3, the database system creates DB session #2 440 for this operation. Within DB session #2 440, the VECTOR_EMBEDDING operator invokes the ML model, and the database engine creates ML runtime session 445 with ML runtime internal representation (PGA) 446. Each database session has its own ML runtime session. Any DB session that needs to use an ML model that is imported into the database server must create an ML runtime session. Caching the ML runtime sessions saves the overhead of loading the ML model from the database dictionary, because the most time-intensive part of generating an ML runtime session is loading the bytes of the ML model.

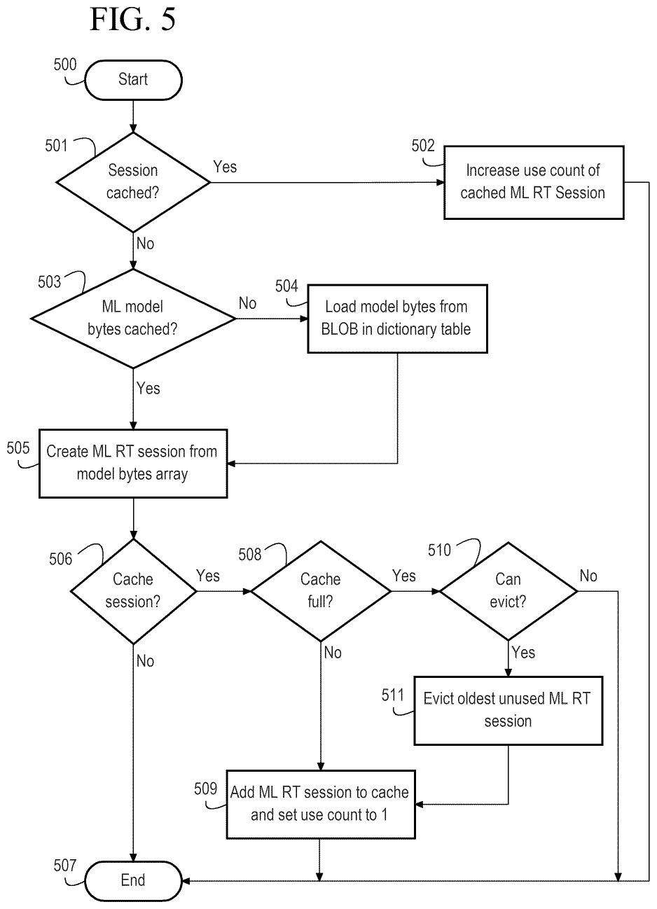

FIG. 5 is a flowchart illustrating operation of providing a machine learning runtime session to a database operator in accordance with an embodiment. Operation starts (block 500) when a database session executes a database operation with an operator that invokes an ML model that is imported into the database server. The database server determines whether a session is cached (block 501). The ML runtime session cache is first probed for the model by the operator using an associated unique object number of the ML model. If a session is cached (block 501: Yes), then the database server increases the use count of the cached ML runtime session and the session is returned to the operator, which will cache it in its runtime state (block 502). Then, operation ends (block 507).

If a session is not cached (block 501: No), then the database server determines whether the ML model bytes are cached (block 503). If the ML model bytes are not cached (block 503: No), then the database server loads the model bytes from a BLOB in the dictionary table (block 504). Thereafter, the database server creates an ML runtime session from the model bytes array (block 505). The ML model bytes may be cached in memory (e.g., in a cache for dictionary object metadata) in which case they may be used immediately to create an ML runtime session. Otherwise, they must be loaded from the BLOB column of a dictionary table. The bytes may be cached (e.g., in the aforementioned cache for dictionary object metadata) before creating the ML RT session.

The database server then determines whether the session for the ML model should be cached (block 506). An ML runtime session for a small model may not be worth caching, especially if the bytes for the model are already cached, because session creation in this case is not very resource-or time-intensive. Thus, caching is attempted only for models whose session creation cost is large enough. If the session is not to be cached (block 506: No), then operation ends (block 507).

If the session is to be cached (block 506: Yes), then the database server determines whether the cache is full (block 508). This determination depends on the policy chosen. A simple strategy is to allow only one cached session. Another strategy is to limit caching to a memory budget (e.g., 1 GB of memory). If the cache is not full (block 508: No), then the ML runtime session is entered in the cache (a simple hash-table that uses database object number as key) and the session use count is set to 1 (block 509). Thereafter, operation ends (block 507).

If the cache is full (block 508: Yes), then at least one session can be evicted. Eviction is possible only for sessions that are not in use, i.e., whose use count equals 0. Among these, one or more sessions may be selected for eviction. Eviction can be based on age and memory needed for the new session. The database server then determines whether one or more sessions can be evicted (block 510). If a session cannot be evicted (block 510: No), then operation ends (block 507).

If a session can be evicted (block 510: Yes), then the oldest session(s) that release enough memory for the new session are chosen, and the database server evicts the oldest unused ML runtime session(s) (block 511). The ML runtime session is then entered in the cache, and the session use count is set to 1 (block 509). Thereafter, operation ends (block 507). If an eviction candidate is found, the session is closed, its memory released, and the new session is entered in the cache before being returned to the operator.

### Batching

In accordance with some embodiments, the ML runtime supports batch inferences, i.e., instead of executing model inference for one input data at a time, inference is executed for multiple inputs at a time. The embodiments include a method for exploiting batch inference in a database that supports rowset processing for expression evaluation. Rowset support for expression evaluation means that an expression is evaluated over multiple rows at once instead of one row at a time.

A scoring operator enabled for rowset would allocate the input and output tensors for the model differently. It will allocate tensors with a batch dimension equal to the size of the input rowset. In general, the rowset size is mostly constant across invocations of the operator for the duration of a query. It may on rare occasion change; therefore, a rowset enabled operator must verify on every invocation whether the rowset size has changed and re-allocate the input/output tensors accordingly.

The use of rowset can be beneficial to queries involving scoring operators in different ways:
For queries feeding large amount of data to an operator by limiting the control flow overhead of interacting one row at a time. This mostly benefit the dataflow operators and expression evaluation engine of the database, not the model inference.
Improved model inference: some models may benefit from batching. Models with many matrix computations comprising large constant weight matrices may benefit from better locality through batching, because multiple inputs can be processed against the same matrix at once, as opposed to running the whole model one input at a time. This is definitively the case when running on graphical processing units (GPUs), where matrix movement across the memory hierarchy (from global memory to local memory) is reduced. To some degree, it may also benefit execution on CPU.

### Query Compilation

Compilation of a query that uses an operator against a ML model proceeds as follow with respect to the scoring operator:
The name of the model specified in the scoring operator is first resolved to a database object identifier, which can be used to retrieve the metadata from the dictionary necessary to perform semantic analysis and type checking.
Privilege to using the model in a query is verified and a compilation error is raised in case of insufficient privilege.
Semantic analysis verifies:
   That the function specified at model import supports the operator;
   That the number of input attributes specified by the operators match that of the ML model and that the input attribute names match those specified with the model when it was imported.
Type checking:
   Verifies that the SQL data type of the value passed as argument to the operator for each input attribute are compatible with the ML data type for the corresponding input attribute.
   Determine the SQL output type for the operator based on the data type of the model output to be used for the operator.
Compile-time information for the scoring operator is updated to indicate that rowset can be supported if the ML model supports batch inference.

### Example Embedding Models and Scoring Operator Examples

In one implementation, the embodiments described herein machine learning models that are trained outside a database system, such as a model for generating vector embeddings for both text and unstructured data, such as images, audio, video, etc., to be imported into a database system. The embodiments also provide scoring operators that are supported by the imported machine learning models such that the operators generate embedding values according to an embedding model.

The following is an example statement for importing a vector embedding model into a database server:

EXECUTE
DBMS_VECTOR.import_onnx_model(‘my_model’, :onnx_st_blob);

The value: onnx_st_blob is a bind variable holding a BLOB that contains the ONNX representation of the model. This example assumes a sentence transformer model that generates vector embeddings. Without additional argument to override default for the function implemented by the model and the name of its input attribute(s), the model is assumed to be an embedding model that supports the VECTOR_EMBEDDING scoring operator and uses “DATA” as an input attribute name.

The following is an example of a table holding a VECTOR value, using the syntax of the database:

```
create table document_paragraphs(
  doc_id NUMBER,
  par_pos NUMBER,
  paragraph VARCHAR2(4000),
  embedding VECTOR(768, float32));
```

The following is an example of using the VECTOR_EMBEDDING operator in a DML operation to generate a vector value from text:

INSERT INTO document_paragraphs VALUES(1241, 0, ‘This is an
example of generating embeddings.’, VECTOR_EMBEDDING (model
USING ‘This is an example of generating embeddings.’ as
data));

The following is an example of using VECTOR_EMBEDDING in a similarity search query to retrieve the top three similar paragraphs:

SELECT paragraph FROM document_paragraphs p
ORDER BY VECTOR_DISTANCE(VECTOR_EMBEDDING(my_model USING
‘example of generating embeddings' as data), p.embedding)
FETCH FIRST 3 ROWS;

The following is an example of working with an image model applied to an image stored as a BLOB:

```
create table product_images(
  product_id NUMBER,
  product_image BLOB,
  embedding VECTOR(512, float32));
```

The following is an example statement for importing a vector embedding model for generating embeddings for images into a database server:

EXECUTE
DBMS_VECTOR.import_onnx_model(‘image_model’, :onnx_igm_blob);

The value: img_blob is a bind variable holding a BLOB that contains the ONNX representation of image model (e.g., resnet50, or clip).

The following is a statement for using the image_model ML model to insert image embeddings into a table.

INSERT INTO product_images(15312, :img,
VECTOR_EMBEDDING(image_model USING :img as data));

The value: img is a bind variable holding an image in a BLOB.

The following statement is a query that uses the image_model ML model:

SELECT p.product_id, p.product_image FROM product_images p
ORDER BY VECTOR_DISTANCE(VECTOR_EMBEDDING(image_model
USING :search_blob as data), p.embedding) FETCH FIRST 3 ROWS;

These examples include statements for importing an ML model into a database system and statements including operators using the imported models.

### DBMS Overview

A database management system (DBMS) manages a database. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, a branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains definition metadata that defines properties of the database object. For example, definition metadata in a database dictionary defining a database table may specify the attribute names and data types of the attributes, and one or more files or portions thereof that store data for the table. Definition metadata in the database dictionary defining a procedure may specify a name of the procedure, the procedure's arguments, and the return data type, and the data types of the arguments and may include source code and a compiled version thereof.

A database dictionary is referred to by a DBMS to determine how to execute database commands submitted to a DBMS. Database commands can access or execute the database objects that are defined by the dictionary. Such database objects may be referred to herein as first-class citizens of the database. A first-class citizen is associated with a database object name, which can be referenced in database commands to identify the first-class citizen to DBMS. The database object name is mapped or otherwise associated with the database object. The DBMS refers to the definition metadata of the first-class citizen to determine how to access or execute the first-class citizen.

A database object may be defined by the database dictionary, but the definition metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. . java file) and the compiled version of the class (i.e. .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data type and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

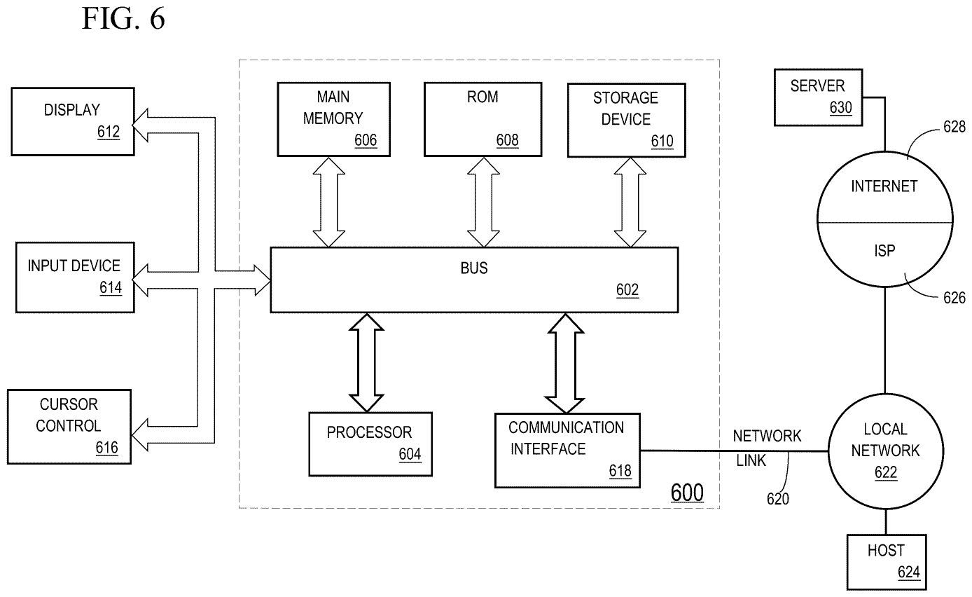

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

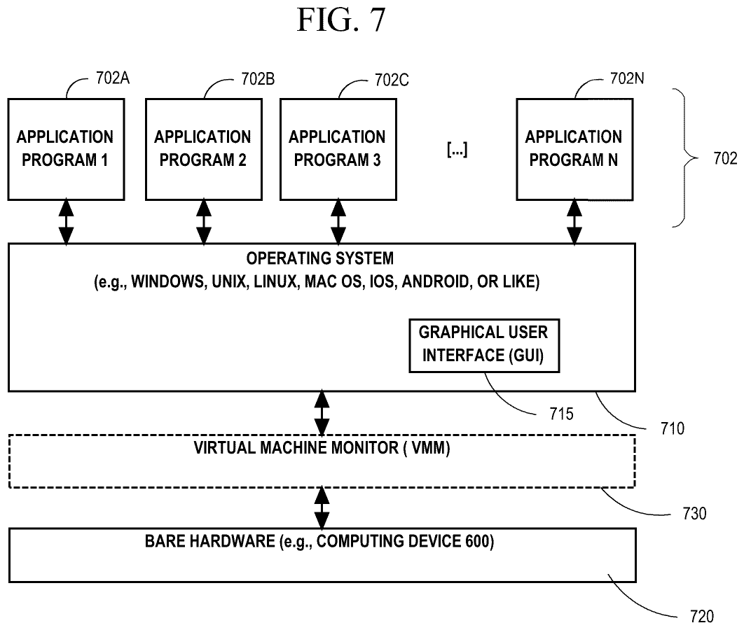

FIG. 7 is a block diagram of a basic software system 700 that may be employed for controlling the operation of computer system 600 upon which aspects of the illustrative embodiments may be implemented. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
defining a trained machine learning (ML) model in a database dictionary of a database system, wherein defining the trained ML model results in creating a named database object that is a first-class citizen of the database system;
compiling, by a database system, a statement comprising an operator, wherein:
the operator references an identifier of a trained machine learning (ML) model, and
the operator includes one or more input attributes that correspond to the trained ML model;
executing, by the database system, the statement, wherein executing the statement comprises:
running, by a machine learning runtime engine within the database system, at least one inference of the trained ML model using the one or more input attributes as inputs to the trained ML model;
passing at least one result returned by the at least one inference of the trained ML model to the operator; and
executing, by the database system, the operator using the at least one result returned by the at least one inference of the trained ML model,
wherein the method is performed by one or more computing devices.

2. The method of claim 1, wherein the trained ML model is imported into the database system by:
receiving a schema qualified object name, a binary object containing the trained ML model, and a descriptor providing information for compiling and executing the trained ML model; and
creating a database object for the trained ML model as a first-class object in the database system.

3. The method of claim 2, wherein:
the descriptor specifies at least one of:
one or more operators supported by the trained ML model,
how one or more values passed to an operator map to one or more inputs of the trained ML model,
how one or more values returned by the trained ML model are passed to an operator, or
how to handle a NULL input.

4. The method of claim 2, wherein the database dictionary for the trained ML model comprises:
a table comprising a binary object representing the trained ML model and a text object representing the descriptor,
a table describing a mapping of model input to input attribute name, and
a table summarizing information inferred from the trained ML model.

5. The method of claim 1, wherein compiling the statement comprises performing one or more of:
resolving a name of the trained ML model to a database object identifier,
verifying privilege to using the trained ML model,
semantic analysis,
type checking, or
updating compile-time information for the operator.

6. The method of claim 1, wherein running the at least one inference of the trained ML model comprises:
creating a runtime session with the machine learning runtime engine; and
caching the runtime session.

7. The method of claim 1, wherein the trained ML model has a function selected from the group consisting of embedding, classification, regression, clustering, reranking, text generation, object-identification, or named-entity recognition.

8. The method of claim 1, wherein:
the trained ML model comprises an embedding model, and
the one or more input attributes comprise an attribute having a text data type or an unstructured data type.

9. The method of claim 1, wherein:
the trained ML model comprises an embedding model, and
the operator comprises a vector embedding scoring operator that generates embedding values according to the embedding model.

10. The method of claim 1, wherein running the at least one inference of the trained ML model comprises running the at least one inference on a plurality of threads in one or more graphical processing units.

11. The method of claim 1, wherein running the at least one inference of the trained ML model comprises running a plurality of batch inferences concurrently.

12. One or more non-transitory computer-readable media storing instructions which, when executed by one or more processors, cause performance of:
defining a trained machine learning (ML) model in a database dictionary of a database system, wherein defining the trained ML model results in creating a named database object that is a first-class citizen of the database system;
compiling, by a database system, a statement comprising an operator, wherein:
the operator references an identifier of a trained machine learning (ML) model, and
the operator includes one or more input attributes that correspond to the trained ML model;
executing, by the database system, the statement, wherein executing the statement comprises:
running, by a machine learning runtime engine within the database system, at least one inference of the trained ML model using the one or more input attributes as inputs to the trained ML model;
passing at least one result returned by the at least one inference of the trained ML model to the operator; and
executing, by the database system, the operator using the at least one result returned by the at least one inference of the trained ML model,
wherein the method is performed by one or more computing devices.

13. The one or more non-transitory computer-readable media of claim 12, wherein the trained ML model is imported into the database system by:
receiving a schema qualified object name, a binary object containing the trained ML model, and a descriptor providing information for compiling and executing the trained ML model;
creating a database object for the trained ML model as a first-class object in the database system.

14. The one or more non-transitory computer-readable media of claim 13, wherein:
the descriptor specifies at least one of:
one or more operators supported by the trained ML model,
how one or more values passed to an operator map to one or more inputs of the trained ML model,
how one or more values returned by the trained ML model are passed to an operator, or
how to handle a NULL input.

15. The one or more non-transitory computer-readable media of claim 13, wherein the database dictionary for the trained ML model comprises:
a table comprising a binary object representing the trained ML model and a text object representing the descriptor,
a table describing a mapping of model input to input attribute name, and
a table summarizing information inferred from the trained ML model.

16. The one or more non-transitory computer-readable media of claim 12, wherein compiling the statement comprises performing one or more of:
resolving a name of the trained ML model to a database object identifier,
verifying privilege to using the trained ML model,
semantic analysis,
type checking, or
updating compile-time information for the operator.

17. The one or more non-transitory computer-readable media of claim 12, wherein running the at least one inference of the trained ML model comprises:
creating a runtime session with the machine learning runtime engine; and
caching the session.

18. The one or more non-transitory computer-readable media of claim 12, wherein the trained ML model has a function selected from the group consisting of embedding, classification, regression, clustering, reranking, text generation, object-identification, or named-entity recognition.

19. The one or more non-transitory computer-readable media of claim 12, wherein:
the trained ML model comprises an embedding model, and
the one or more input attributes comprise an attribute having a text data type or an unstructured data type.

20. The one or more non-transitory computer-readable media of claim 12, wherein:
the trained ML model comprises an embedding model, and
the operator comprises a vector embedding scoring operator that generates embedding values according to the embedding model.
